(19) United States
(12) Patent Application Publication
(10) Pub. No.: US 2006/0287999 A1
(43) Pub. Date: Dec. 21, 2006

(54) Document file obtaining method, document processing apparatus, and document file obtaining program

(75) Inventors: Hiroyuki Kawabata, Kawanishi-shi (JP); Yoshiyuki Tamai, Itami-shi (JP); Masami Yamada, Sennan-gun (JP); Hisashi Uchida, Kuze-gun (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/320,792

(22) Filed: Dec. 30, 2005

(30) Foreign Application Priority Data
Jun. 21, 2005 (JP) 2005-181277

(51) Int. Cl. G06F 17/30

(52) U.S. Cl. 707/5; 707/3

(57) ABSTRACT

The present invention provides a document file obtaining method comprising: a specifying step of specifying, among one or more document file storing apparatuses, a document file storing apparatus from which to obtain a processed document file; a receiving step of receiving processing history information from the specified document file storing apparatus; a selecting step of displaying pieces of received processing history information whose processing date and time is within a predetermined time period, and selecting at least one piece of the displayed processing history information; and an obtaining step of obtaining a document file associated with the selected piece of the processing history information from the specified document file storing apparatus.

### CROSS-REFERENCE TO RELATED APPLICATION

This application is based on an application No. 2005-181277 filed in Japan, the contents of which is hereby incorporated by reference.

### BACKGROUND OF THE INVENTION

(1) Field of the Invention

The present invention relates to a method used by a document file obtaining apparatus, which is connected to a document file storing apparatus, to obtain a document file, and particularly relates to a technique that enables a user to easily select a desired piece of document data from a plurality of pieces of document data.

(2) Description of the Related Art

Among document processing apparatuses having functions of a scanner, a copier, a printer, a FAX and so on (e.g. MFP: Multi Function Peripheral), document processing apparatuses using a BOX, which stores document files, have been developed in recent years.

A BOX is a storage region on a storage device, such as a HDD (Hard Disk Drive), which is allocated to store document files. The document files, which have been generated by a document processing apparatus performing a scanning and so on, are stored in the BOX. Accordingly, other apparatuses can use the document files.

By the way, users sometimes wish to reuse the document files by selecting and transferring them to a document file obtaining apparatus (terminal apparatus).

With a conventional technique, such a transfer is performed using a document file operation tool installed in the document file obtaining apparatus. In other words, to transfer the desired document files to the document file obtaining apparatus, the user is required to instruct the document file obtaining apparatus to perform the following operations (A) to (D):

(A) To start up a document file operation tool (e.g. utility software for the BOX);

(B) To select a document file to be transferred, from document files displayed in list form or as thumbnails;

(C) To drag and drop the icon of the selected document file into a transfer destination folder, for instance, to copy the selected document to the transfer destination folder; and

(D) To terminate the document file operation tool.

However, the operation tool usually displays only a list including all the names of the document files in order of created date and time (or alphabetical order).

Therefore, if the number of the selectable document files is large, the user is required to spend a lot of time to find the document file to be transferred.

Such operations are burden especially on a novice user who is not accustomed to the operations. It is possible that the user feels at a loss what to do when the user faces enormous numbers of the document files.

### SUMMARY OF THE INVENTION

The object of the present invention is to solve the problem described above, and provide a document file obtaining method and so on that enables the user to easily select a desired document file from document files stored in a document processing apparatus.

To achieve the object, the document file obtaining method according to the present invention is a document file obtaining method that is used by a document file obtaining apparatus to obtain a processed document file from a document file storing apparatus which stores one or more processed document files in one-to-one association with one or more pieces of processing history information, each including a processing date and time, the document file obtaining method comprising: a specifying step of specifying, among one or more document file storing apparatuses, a document file storing apparatus from which to obtain a processed document file; a receiving step of receiving processing history information from the specified document file storing apparatus; a selecting step of displaying pieces of received processing history information whose processing date and time is within a predetermined time period, and selecting at least one piece of the displayed processing history information; and an obtaining step of obtaining a document file associated with the selected piece of the processing history information from the specified document file storing apparatus.

Here, the “document file” is data relating documents, stored and managed by the document processing apparatus, including document data generated by software such as word processor software, spreadsheet software, database software, presentation software, image data generated by scanning, and image data transmitted or received by FAX.

A document processing apparatus according to the present invention is, document processing apparatus comprising: a processing unit operable to perform a predetermined processing on a document file; a storing unit operable to store one or more processed document files in one-to-one association with one or more pieces of processing history information each including a processing date and time; a display control unit operable to display pieces of the processing history whose processing date and time is within a predetermined time period; and a receiving unit operable to receive a selection of at least one of the displayed pieces of the processing history information.

A document file obtaining program according to the present invention is a document file obtaining program that is used by a document file obtaining apparatus to obtain a processed document file from a document file storing apparatus which stores one or more processed document files in one-to-one association with one or more pieces of processing history information, each including a processing date and time, the document file obtaining program comprising: a specifying step of specifying, among one or more document file storing apparatuses, a document file storing apparatus from which to obtain a processed document file; a receiving step of receiving processing history information from the specified document file storing apparatus; a selecting step of displaying pieces of received processing history information whose processing date and time is within a predetermined time period, and selecting at least one piece of the displayed processing history information; and an obtaining step of obtaining a document file associated with the selected piece of the processing history information from the specified document file storing apparatus.

With the stated structures, document file obtaining method, the document processing apparatus, or the document file obtaining program first has user specify, on a screen displayed by the document file obtaining apparatus, a document processing apparatus from which the document file should be obtained. This narrows the target of the obtainment down to the document files stored in the specified document processing apparatus. On the next screen of the document file obtaining apparatus, only the pieces of the processing history information each having the processing date and time that is within a predetermined time period are displayed. This means that the document file obtaining apparatus displays only the pieces of the processing history information that are doubly narrowed down based on the judgement regarding which apparatus is the target apparatus and when is the processing date and time.

In other words, based on the judgement above, the user can find the desired document file more easily than the conventional technique.

Here, the predetermined period may be a period between a current time and a predetermined time in the past.

With the stated structure, for instance, by setting a recent time to the predetermined time, the user can easily find the desired document file processed at the recent time.

Here, the receiving step may receive pieces of the processing history information whose processing date and time is within the predetermined time period.

With the stated structure, it becomes possible to reduce the transaction on the network.

Here, the selecting step may include: a periodical classification menu displaying substep of displaying a periodical classification menu including one or more periods into which pieces of the received processing history information are classified based on the time and date; a period specifying substep of specifying at least one of the periods; and a specified period menu displaying substep of displaying a specified period menu including one or more pieces of the processing history information classified in the selected period.

With the stated structure, the user can narrow down candidates of the target document files step by step based on the processing date and time. This means that the user can find the desired document file more easily than the conventional technique.

Here, the periodical classification menu displaying substep may display the menu that includes a first period between a current time and a first predetermined time in the past, and a second period between the first predetermined time and a second predetermined time that is further in the past than the first predetermined time.

The user often searches for document files that have been processed recently. Accordingly, if a recent time is set to the predetermined time, the user can easily find the desired document file that has been processed recently.

Here, among the one or more periods included in the periodical classification menu, a period nearer to the current time may have a shorter time length.

Document files processed more recently are more often searched for by the user. Further, the processing date and time of the document file processed more recently are more accurately remembered by the user. Accordingly, the stated structure improves the convenience of the user, regarding the search.

Here, among the one or more periods, the periodical classification menu may display a period in which at least one piece of the processing history information is classified.

With the stated structure, the periodical classification menu does not display a period in which none of the processing history information is classified. This reduces the amount of the displayed information, and improves the convenience of the user, regarding the search.

Here, the specified period menu may be displayed as a submenu of the periodical classification menu.

This structure can have the user intuitively understand how to narrow down the processing dates and times displayed step by step.

Here, each piece of the processing history information may further include a user attribute, the selecting step may include a user name selection menu displaying substep of displaying a user name selection menu used for selecting a user name of a user of the document file storing apparatus, and at least one of the periodical classification menu and the specified period menu may include the processing history information which includes the user attribute corresponding to the user name selected from the user name selection menu.

The user often searches for document files relating to the user himself. With the stated structure, the user can quickly find the document file that is processed based on the instruction from the user himself.

Here, the user attribute indicates that the processing history information may not belong to any specific user; and at least one of the periodical classification menu and the specified period menu may include the processing history information which includes the user attribute indicating that the processing history information does not belong to any specific user.

Here, the document file storing apparatus may include a processing unit operable to perform a predetermined processing on a document file, the processing history information may include information that specifies a type of the processing, and the specified period menu may include the processing time and date and the type of the processing.

With the stated structure, the user can find the desired document file based on the type of the document file.

Here, the processing performed by the processing unit may be at least one of scanning, FAX transmission, printing, and copying.

The user often searches for a document file that is processed based on the instruction from the user himself (The document file mentioned here is a document file on which active processing, such as a generation or a transmission is performed by the user's instruction. Accordingly, this excludes the document file on which passive processing such as receiving is performed). The stated structure improves the convenience of the user, regarding the search.

Here, the periodical classification menu may be a context menu that is displayed in a window showing contents of a predetermined directory, and the obtaining step may transmit, to the document file storing apparatus, an obtainment request which includes information that specifies the directory as an obtainment target directory.

With the stated structure, the user can specify the above directory as the obtainment target directory without performing any additional operation for specifying the obtainment target directory.

Here, the periodical classification menu displaying substep may display the periodical classification menu in response to a single touch of a key or a button of an input device of the document file obtaining apparatus.

With the stated structure, the user can display the periodical classification menu without performing any complicated operation. This improves the convenience of the user.

Here, the input device may be a mouse and the single touch may be a single click of a right button of the mouse.

Regarding the document processing apparatus, the document processing apparatus may be connected to another document processing apparatus via a network, and may further include: a receiving unit operable to receive the processing history information from said another document processing apparatus; an obtaining unit operable to obtain one or more document files in one-to-one association with the one or more pieces of the processing history information, and the display control unit operable to receive a specification of a document processing apparatus, and if said another apparatus is specified, the receiving unit receives the processing history information from said another document processing apparatus.

Here, the display control unit may display a menu including one or more periods into which the pieces of the processing history information are classified based on the time and date, the receiving unit may further receive a selection of at least one of the displayed periods, and in response to the selection, the display control unit may further display a specified period menu including pieces of the processing history classified in the specified period.

Regarding the document file obtaining program, the selecting step may include: a periodical classification menu displaying substep of displaying a periodical classification menu including one or more periods into which pieces of the received processing history information are classified based on the time and date; a period specifying substep of specifying at least one of the periods; and a specifiedperiod menudisplaying substep of displaying a specified period menu including one or more pieces of the processing history information classified in the selected period.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 shows a structure of a file system 3;

FIG. 2 is a functional block diagram showing a structure of an MFP 1;

FIG. 3 shows a document file history table 29 stored in a document file history managing unit 28;

FIG. 4 is a functional block diagram showing a structure of a PC 100;

FIG. 5 is a sequence diagram schematically showing operations performed for transferring a document file, which is selected from document files stored in a MFP 1, to a PC 100;

FIG. 6A and FIG. 6B show a main part of a screen displayed on a monitor 112, and a transition of a menu used for selecting a document file;

FIG. 7A and FIG. 7B show a main part of a screen displayed on a monitor 112, and a transition of a menu used for selecting a document file;

FIG. 8A and FIG. 8B show a main part of a screen displayed on a monitor 112, and a transition of a menu used for selecting a document file;

FIG. 9 shows a document file selecting menu 200 according to the modification; and

FIG. 10A and FIG. 10B show a screen displayed on an operation panel unit 22 of an MFP 1 according to the second embodiment.

### DESCRIPTION OF THE PREFERRED EMBODIMENTS

The following describes embodiments of the present invention with reference to the drawings.

### The First Embodiment

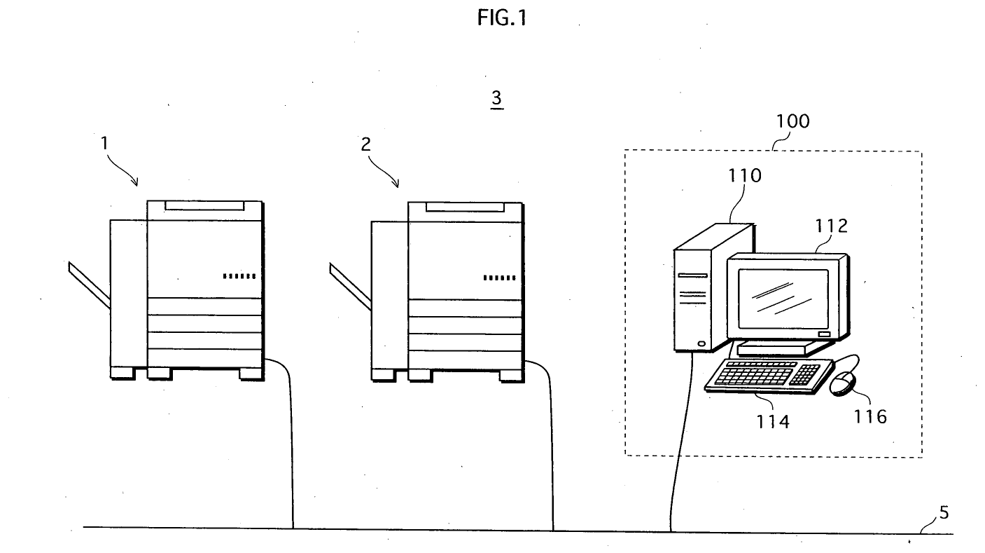

FIG. 1 shows a structure of a file system 3.

The file system 3 includes an MFP 1, an MFP 2 and a PC 100. These apparatuses are connected together via a LAN cable 5, and form a LAN.

The PC (Personal Computer) 100 as a document file obtaining apparatus includes a main body 110, a monitor 112, a keyboard 114 and a mouse 116. The mouse 116 is of a two-button type having a left button and a right button.

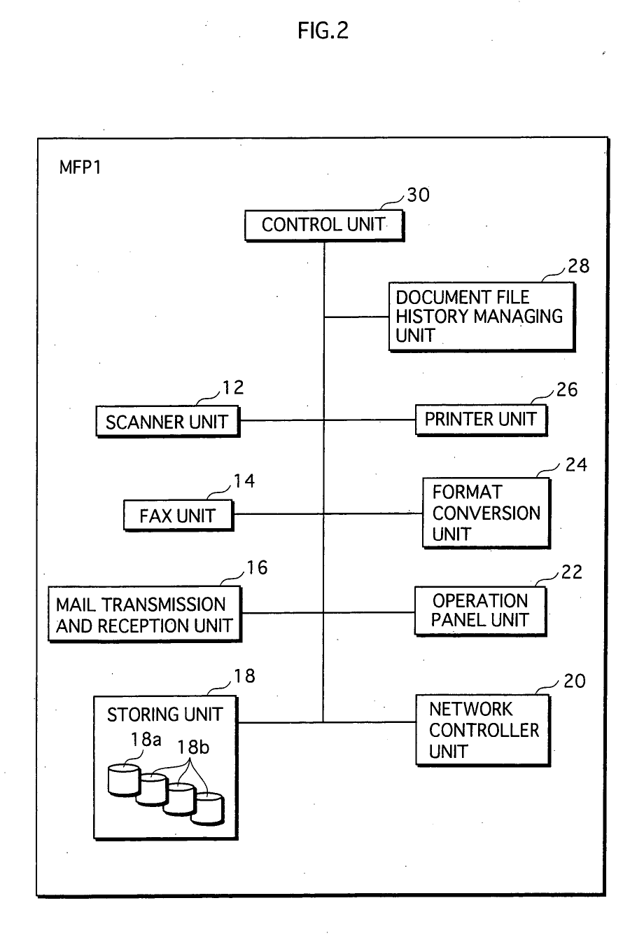

FIG. 2 is a functional block diagram showing a structure of the MFP 1. The MFP 2 has the same structure as the MFP 1. Therefore, only the structure of the MFP 1 is explained below.

The MFP 1 includes a scanner unit 12, a FAX unit 14, a mail transmitting and receiving unit 16, a storing unit 18, a network controller unit 20, an operation panel unit 22, a format conversion unit 24, a printer unit 26, a document file history managing unit 28 and a control unit 30. The following describes the function of each unit.

The scanner unit 12 scans a document, which is placed on a sheet feeder (not illustrated), to generate image data.

The FAX unit 14 transmits and receives a FAX via telephone lines.

The mail transmitting and receiving unit 16 includes a mailer, and generates, transmits and receives e-mails.

The storing unit 18 includes a HDD (Hard Disk Drive) including a temporary BOX 18a and a user BOX 18b. The HDD may be replaced by a rewritable recording medium, such as DVD and flash memory.

The temporary BOX 18a automatically stores all the document files managed by the MFP 1, such as image data generated by scanner unit 12, image data of FAX transmitted or received by the FAX unit 14, attached file data transmitted or received by the mail transmitting and receiving unit 16 and print data printed by the printer unit 26. All the document files processed by the MFP 1 are temporarily stored in the temporary BOX 18a.

The temporary BOX 18a is for temporarily storing data. The document files stored in the temporary BOX 18a will be automatically deleted after a predetermined period, whose length may be predetermined by the user or set according to a file attribute (private/public) of the document file. This makes available space on the HDD.

In this embodiment, the document files managed by an MFP are automatically saved. This is very effective when the user wishes to reuse the document that the user has previously used.

However, the files are not necessarily saved automatically. Only some of the document files specified as save targets by the user may be saved. Or, only some of the document files not specified as deletion targets by the user may be saved.

The user BOX 18b is a BOX assigned to each user of the MFP 1. The user BOX 18b may be assigned to each user, or to each division (group) in a company and so on.

The network controller unit 20 includes a NIC (Network Interface Card) for instance, and transmits and receives data to and from other apparatuses in the LAN.

The operation panel unit 22 includes a liquid crystal panel, a touch-sensitive panel placed on the front side of the liquid crystal panel, and push buttons. The operation panel unit 22 displays several kinds of information and receives instructions from the user.

This operation panel unit 22 is usually smaller than a monitor of the document file obtaining apparatus due to the structure thereof, and the display resolution is not very high. Accordingly, there are user demands to check and edit document files, which are managed by the MFP 1, with an external apparatus, namely the document file obtaining apparatus.

The format conversion unit 24 converts a format of the image data.

The printer unit 26 performs print processing for printing the received data on a sheet. The printer unit 26 also prints a document data scanned by the scanner unit 12.

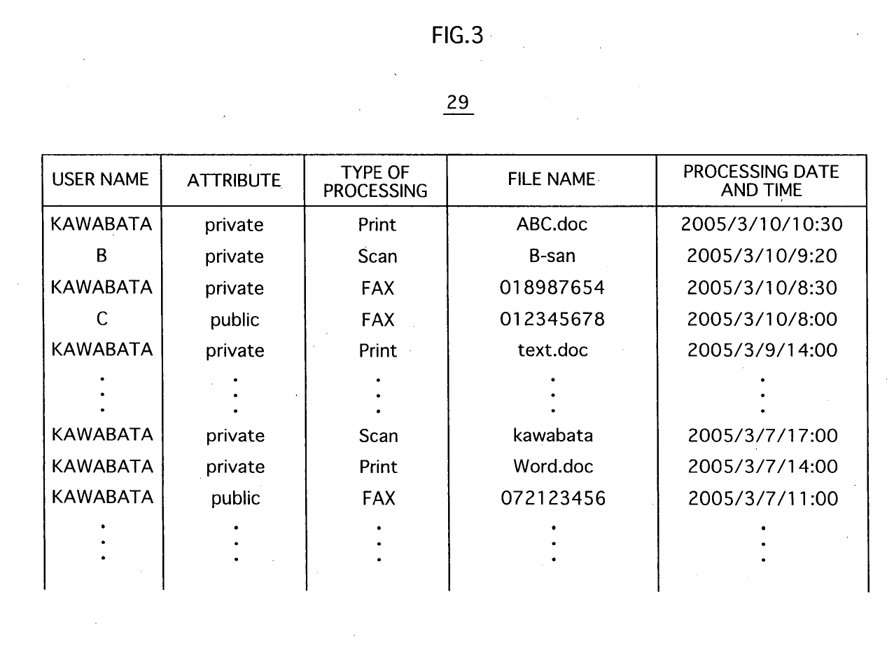

The document file history managing unit 28 manages history information of document files processed by the MFP 1 and stored in the temporary BOX 18a. More specifically, every time the document file is subjected to the processing (which includes generation, change, and transmission and reception of the document file), a user name of the user who has made an instruction for the processing, a processing date and time, a type of the processing (a job name) and so on are stored as processing history information in association with the location of the document files stored in the temporary BOX 18a. Further, the document file history managing unit 28 updates a document file history table 29 (See FIG. 3).

Control unit 30 is structured by hardware such as a CPU, a RAM and a ROM, and controls operations performed by each unit included in the MFP 1.

FIG. 3 shows the document file history table 29 stored in the document file history managing unit 28.

As FIG. 3 shows, the document file history table 29 is a table relating to a processing history of the document file, and includes items of “user name”, “attribute”, “processing type”, “file name”, and “processing date and time”.

The item “user name” is the name of the user who has instructed the MFP 1 to process the document file.

The item “attribute” is the attribute of the document file. A value “private” indicates that the document file is a user document file that belongs to a specific user, and a value “public” indicates that the document file is a shared document file that does not belong to any specific user (i.e. open to public).

The item “processing type” indicates the type of the processing, such as “print”, “scan” and “FAX”.

The item “file name” is a file name that is temporary given to the document file. The filename is different according to the type of the job: (A) If the job is a print job, the name of the document that has been the target of the printing becomes the file name; (B) If the job is a scan job, the name of the user who has made the instruction for the scanning becomes the filename; and (C) If the job is a FAX transmission, the destination phone number of the FAX becomes the file name.

Although not shown in FIG. 3, the document file history table 29 also includes a file path which indicates the location of the original document file stored in the temporary BOX 18a. For instance, the file path of the file “ABC.doc” is “¥temporaryBOX¥ABC.doc”.

The file path as location information may be replaced by anything associated with the document file. For instance, a unique file names may be used as the location information. Also, an ID may be used as the location information and the association with the ID and the file name may be shown in list form.

The item “processing date and time” indicates the date and time when the document file was processed.

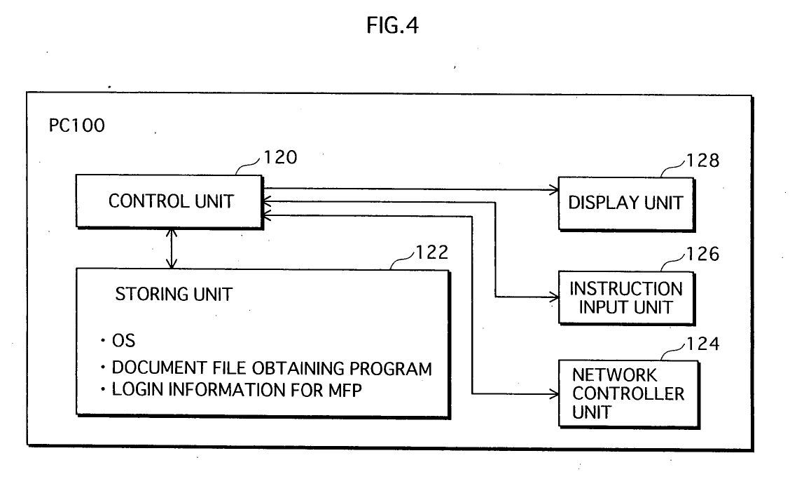

FIG. 4 is a functional block diagram showing a structure of the PC 100.

The PC 100 includes a control unit 120, a storing unit 122, a network controller unit 124, an operation input unit 126, and a display unit 128.

The control unit 120 controls the operations performed by the units included in the PC 100.

The storing unit 122 is structured by a HDD, in which Windows XP (TM) as an OS (Operating System) and a document file obtaining program according to this embodiment are installed.

The storing unit 122 also stores user names and their respective passwords that are required for the authentication. The user names and the passwords are associated with each other on a one-to-one basis, and stored in the storing unit 122 as login information for the MFP 1 and the MFP 2.

The network controller unit 124 transmits and receives data to and from other apparatuses included in the LAN.

The operation input unit 126 is structured by input devices such as the keyboard 114 (see FIG. 1) and the mouse 116, and receives instructions input by the user.

The display unit 128 includes the monitor 112, and displays several kinds of information to the user.

Flow of Document Transfer

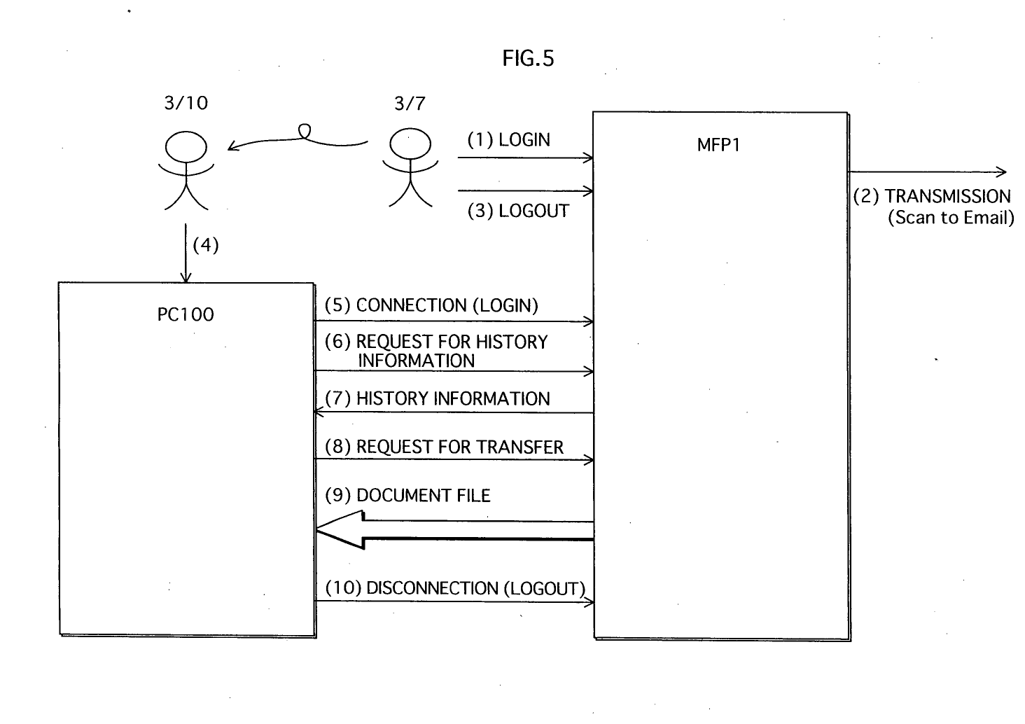

FIG. 5 is a sequence diagram showing the flow of the document transfer in which a designated document file among document files stored in the MFP 1 is transferred to the PC 100.

The flow is described below by taking the following example:

(A) At 17:00 on Mon 7^{th} Mar. 2005: A user (user name: kawabata) has the MFP 1 scan the document, and transmits the generated image data by attaching the data to an e-mail (Scan-to-Email); and

(B) On Thu 10^{th} Mar. 2005: The user checks, by PC 100, whether the image data is appropriately generated according to the user's intension.

(1) The user operates the operation panel unit of the MFPL to log in to the MFP 1 through the authentication procedure.

(2) The user has the scanner unit 12 scan the document, and transmits the generated image data to a predetermined address by attaching the data to an e-mail (Scan to Email). At this moment, the document file history management unit 28 adds additional pieces of information to the image data, namely “kawabata” as the user name of the user who has instructed the processing, “2005/3/7/17:00” as the processing date and time, and “Scan” as the processing type. Then, the document file history table 29 is updated as the processing history information. After that, the image data is stored in the temporary BOX 18a, and information as to the location of the image data is added to the processing history information.

(3) After the processing is finished, the user logs out from the MFP 1.

(4) Three days later, the user starts operating the PC 100 to obtain the image data.

(5) The user logs in to the MFP 1 from the PC 100 using the user name “kawabata”. To perform this login, the PC 100 transmits login information for the MFP 1 stored in the storing unit 122 of the PC 100, or login information input to the PC 100 by the user.

(6) The PC 100 transmits, to the MFP 1, a request for obtaining the processing history information that matches conditions designated by the user, such as the attribute, the processing date and time and the user name.

(7) The MFP 1 receives the request, refers to the document file history table 29, and returns the login information that matches the conditions to the PC 100.

(8) The PC 100 displays a menu that is used by the user for selecting a document file, based on the returned processing history information. Then, the PC 100 receives an instruction from the user to select the document file that is to be obtained. Then, the PC 100 transmits a request for transferring the document file to the MFP 1.

(9) The MFP 1 refers to the location information of the selected document, which is included in the processing history information of the selected document, to specify the location of the document file, and transmits the document file to the PC 100.

(10) The user logs out from the MFP 1.

In (6) of FIG. 5, the easiest way to obtain the processing history information is to transmit, to the MFP 1, a request for obtaining the processing history whose processing date and time is within a predetermined period from the current time (the time when the request is transmitted). The predetermined period is, for instance, within a day, within five hours and so on. The system is preferably structured so that the user can select the period. The user often wishes to obtain the document file that has been most recently processed. With the concept of the predetermined period, the object can be easily achieved.

However, the user not necessarily wishes to obtain the document file that is processed within the predetermined period. Therefore, it is preferable to prepare a more general obtaining method.

As an example of such a method, the following describes an obtaining method corresponding to (4) and later, among (1) to (10) described above.

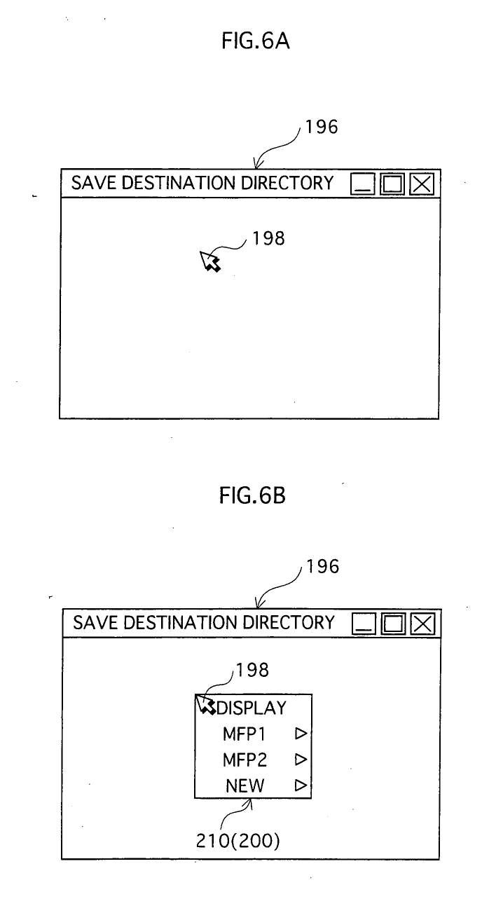

Each of FIG. 6 to FIG. 8 shows a main part of a screen displayed on the monitor 112, and a transition of a menu on which the user select a document file.

Firstly, as FIG. 6A shows, a mouse cursor 198 is located in a window 196 which represents a destination directory (a destination folder).

Next, as FIG. 6B shows, if the user clicks the right mouse button on the window 196, the window 196 is activated and an apparatus selection menu 210 as a right-click menu (a context menu) is displayed (A document file selection menu 200 is a hierarchical menu.).

The items included in the apparatus selection menu 210 are added to the right-click menu when the document file obtaining program is installed in the Windows XP as the OS. This is realized by information which is added into the registry at the time of the installation and indicates that the items should be added to the menu.

This apparatus selection menu 210 includes items “MFP 1” and “MFP 2”, which represent document processing apparatuses connected to the PC 100.

If the user selects the item “MFP 1” by pointing to the item with the cursor 198, the login information for the MFP, which is stored in the storing unit 122 of the PC 100, will be transmitted to the MFP 1, and then the user can login the MFP 1 through the authentication (The system goes into an authentication mode).

Here, if the user points to the item “New” with the cursor 198, a submenu for creating a new file, a new folder and so on will be displayed. The item “New” is originally prepared by the OS and well known. Therefore, it is not explained here.

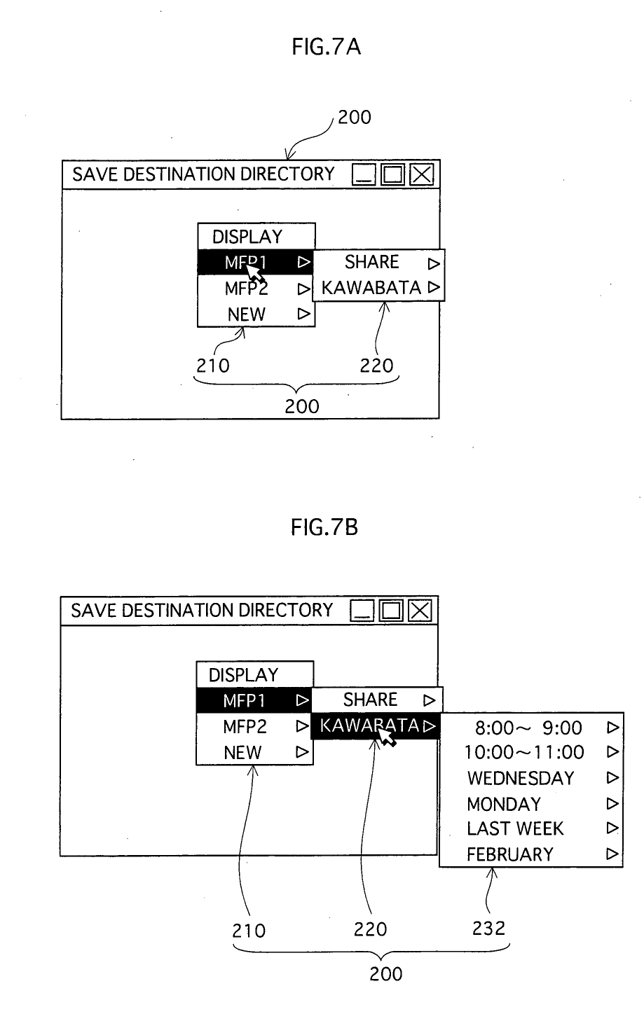

After the login is completed, a user name selection menu 220 will be displayed, as FIG. 7A shows.

The user selection menu 220, including items “share”, and “kawabata” which is the login user name, is displayed in list form.

Next, if the user points to the item “kawabata” with the cursor 198, a periodical classification menu 232 (FIG. 7B) will be displayed. In this case, the periodical classification menu 232 includes documents to which the user name “kawabata” is added as additional information.

If the user points to the item “share” with the cursor 198, the periodical classification menu 232 will be displayed. In this case, the periodical classification menu 232 includes only documents to which the “public” attributes are added as additional information (not illustrated).

In the periodical classification menu 232, the documents are classified based on time periods (8:00-9:00, 10:00-11:00) and the date (Wednesday, Monday, Last week, February) according to the date and time when the documents are processed, and displayed as a list.

In the periodical classification menu 232, the period is nearest to the current time at the top of the list, and furthest at the bottom of the list. For instance, documents processed in the same day as the current date are classified on an hour basis. Document processed in the same week as the current date, except for the documents above, are classified based on the day of the week. In this way, the documents are more broadly classified as the times when the documents are processed become distant from the current time.

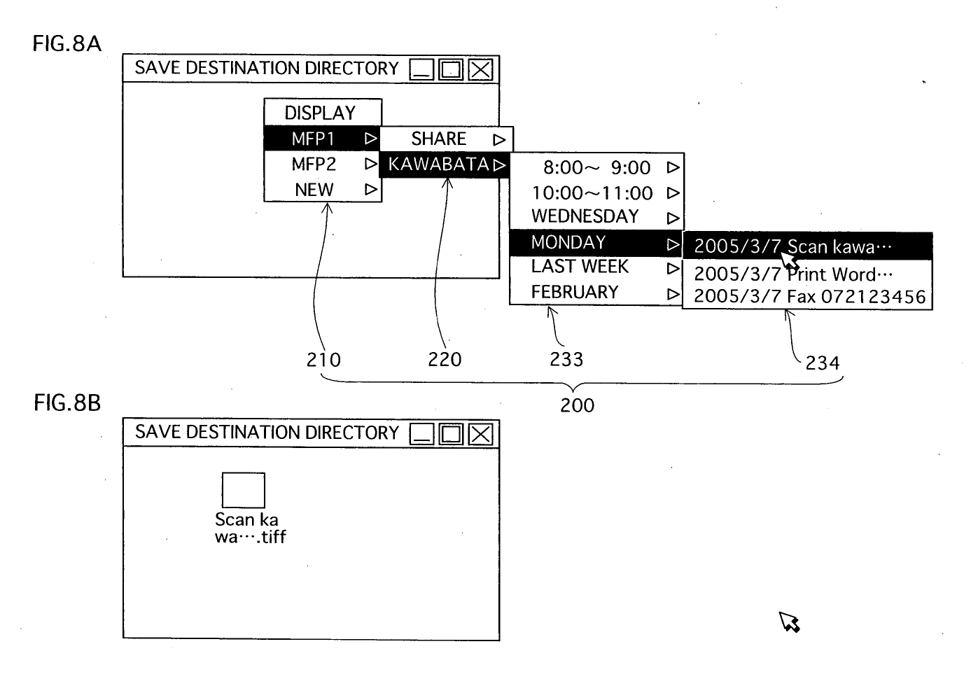

If the user selects the item “Monday” in the periodical classification menu 232, a specified period menu 234 will be displayed as a submenu of the menu 232 (FIG. 8A).

The specified period menu 234 is a menu for displaying processing history information of a document classified into the selected (specified) period. In FIG. 8A, only pieces of the processing history information of the documents classified in “Monday”, which is the selected period (2005/3/7), are displayed in list form.

Each item in this displayed list includes a processing date, a type of the processing and a file name in this order.

In FIG. 8A, the processing date (3/7) is displayed, but the processing time is not displayed. However, it is preferable that the processing time is displayed as well.

If the user points to the item “2005/3/7 Scan Kawa . . . ” in the specified period menu 234 and clicks the left button of the mouse 116, the MFP 1 specifies the save destination directory as the transfer destination, and the document file having the selected processing history information “2005/3/7 Scan Kawa . . . ” will be transferred to the save destination directory, and copied therein (FIG. 8B).

The user often remembers the date and time when he made an instruction for processing a document.

According to the first embodiment, the specified period menu 234 displays only the pieces of the processing history information of the documents processed on Monday (2005/3/7), which is the period selected from the periodical classification menu 233. Therefore, the user can search for a desired document step by step based on the processing date and time. This enables the user to find the desired document more easily compared to conventional ways.

Especially, if there are a lot of selectable document files, the user can narrow down the pieces of the processing history information step by step, and easily find the desired document.

Also, the user often remembers the type of processing, such as Scan and Fax transmission. Therefore, the user can find the desired document using the type of the processing as a clue for the search, if the type of the processing is displayed in the menu.

Also, the user often clearly remembers the type of processing that he instructed by himself. Therefore, it is preferable that the type of processing includes Scan, Fax transmission, Print, Copy and Mail transmission and so on.

Furthermore, documents processed at a time nearer to the current time are more possibly reused by the user compared to old documents (e.g. a case where user generates image data by scanning a document, and confirms the generated data by a PC). As described in this embodiment, the classification becomes more precise as the date and time when the document is processed is closer to the current date and time. This makes the search more convenient.

In addition, the user usually remembers about recent events clearly, but the memory of the past events often becomes vague. For instance, if the user generates a document file today, the user possibly remembers when the document file is generated. However, the user might not remember when if the user generated the document in the distant past. This is also the basis for the fact that the stated classification is preferable.

Note that the present invention is not limited to the first embodiment described above.

Modification

In this modification, documents processed at or after a past certain time and documents processed before the certain time are separately displayed.

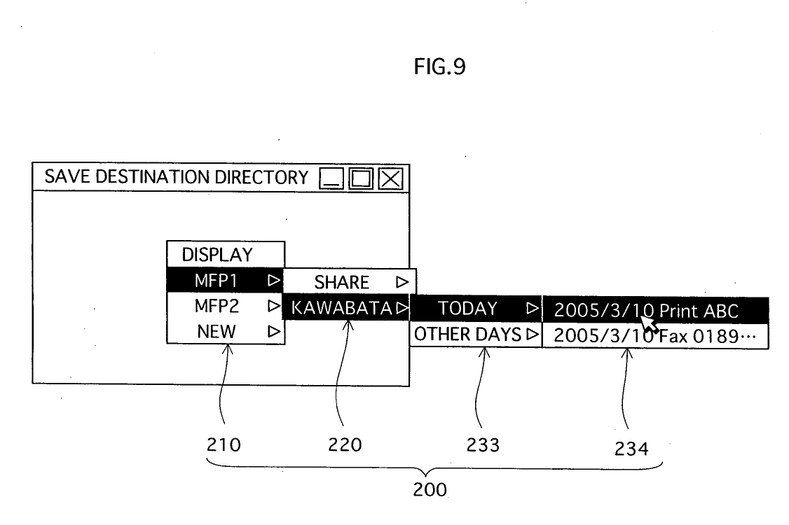

FIG. 9 shows a document file selecting menu 200 according to the modification. In this figure, the same signs are given to the same components as the first embodiment, and they are not described here.

A recent menu 233 is displayed as a submenu of the user name selection menu 220, and the specified period menu 234 is displayed as the submenu of the recent menu 233.

The recent menu 233 includes items “Today” and “Other days”.

In the specified period menu 234, pieces of processing history information of documents which have been processed “Today” are displayed.

As described above, documents processed at a time nearer to the current time are more possibly reused by the user compared to old documents. This modification improves the convenience of the user at the time of searching for recent document files.

Here, items “Specified period” and “Other periods” may be displayed instead of the recent menu 233, and if the user selects the “Specified period”, the specified period menu, which includes pieces of the processing history information of document files which are processed in the specified period, may be displayed. For instance, in the case where the user remembers that the desired file was processed last week, if “last week” can be set as the specified period, the user can easily find the desired file.

Supplemental Descriptions

(1) Input for Displaying Document File Selection Menu 200 as Context Menu

In the first embodiment, the selection menu 200 is displayed when the user clicks the right button of the mouse 116. However, the input device is not limited to the mouse 116. The input button is not limited to the right button as well.

For instance, with the Windows XP™, the user can display the context menu by pressing “SHIFT+F10”.

The point is to enable the user to display the selection menu by a simple operation, for instance with a single click of the button so as to provide a convenience of the user.

(2) Displaying Selection Menu without Generating New Window Provided for Tool

Conventionally, to transfer a document file stored in the document processing apparatus, it has been necessary to start up a tool for handling the document file, select the document to be transferred, and then specify the transfer destination as described in the “Related Art”.

However, if the tool is stared up, a new window is generated and it deteriorates the work environment for the user. Also, the user is required to close the generated new window after the transfer is completed.

According to the first embodiment, the document file selection menu 200 is a context menu in the active window of the save destination directory. Therefore, the new window is not generated. Further, once the document file selection menu 200 is displayed, the user can select a desired document file by just moving the mouse cursor 198.

(3) Time Period

(A) In the first embodiment, the specific period menu 234 (see FIG. 8) displays only document files which have been processed in the period selected from the periodical classification menu 232. However, it is possible to also display documents processed at a time a little bit out of the period.

More specifically, if the period 9:00-10:00 is specified, a document file which is processed at 8:50, 10:20 and so on may be displayed.

(B) In the first embodiment, the user can specify only one period. However, a plurality of periods may be accepted.

(4) Temporary Box 18a

To save the storage capacity, a document file having the “private” attribute, which are stored in the temporary box 18a (see FIG. 2), may be deleted when the PC 100 obtains the document This is because a document file having the “private” attribute is rarely reused.

On the contrary, it is preferable that a document file having the “public” attribute is not deleted regardless of whether the document is obtained by the PC 100. This is because a document file having the “public” attribute is often reused by the public.

(5) Save Location of Document File History Table

In the first embodiment, to obtain the processing history information, the PC 100 transmit a request, to the MFP 1, for the processing history information of the document files which meet the conditions determined by the user, such as the attribute, the processing date and time, the user name and so on. However, the PC 100 may periodically obtain the document file history table stored in the MFP, and store the table in the storing unit 122 of the PC 100.

Also, the PC 100 may generate and manage the document file history table stored in the MFP.

Accordingly, it becomes possible to skip the process for transmitting the request to the MFP. This shortens the time required for displaying the menu.

(6) Document File Obtaining Program

The document file obtaining program according to the present invention can be recorded on several kinds of recording media that are readable by a PC, such as magnetic disks including a magnetic tape and a flexible disk, optical recording media including a DVD, a CD-ROM, a CD-R and an MO, and flash memory type recording media including a compact flash™. The program may be produced or transferred in a form of such a recording medium, and transmitted and provided via a network such as a broadcast, electric communication network, a satellite communication network, and a wired or wireless communication network including the Internet.

### The Second Embodiment

In this embodiment, the document file selection menu is displayed on an operation panel unit 22 of the MFP 1. Here, it is assumed that the user (User name: Kawabata) selects a document file from the MFP 1, not from the PC 100. Note that the same components as in the first embodiment are not described and the differences are mainly described here.

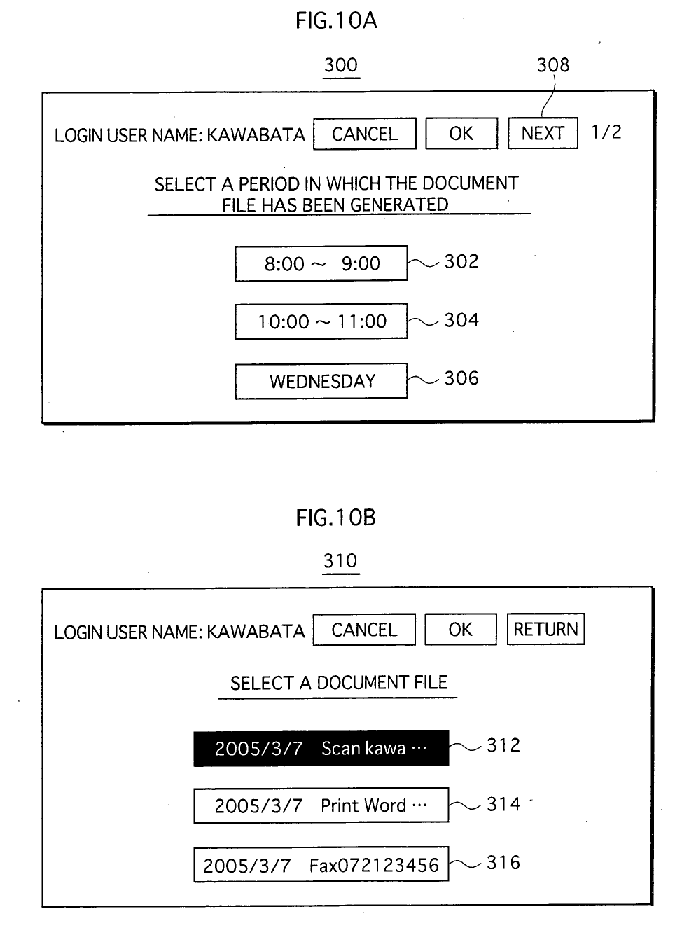

FIG. 10 shows a screen displayed on the operation panel unit 22 of the MFP 1 according to the second embodiment.

The user (User name: Kawabata) now logs in the MFP 1.

In FIG. 10A shows a periodical classification menu 300 in which stored document files are classified based on the date and time representing the time when the documents are generated (processed). Period selection keys 302, 304 and 306 are touch-sensitive. If a Next key 308 is pressed, the next page, which shows the periodical classification menu including “Monday, Last week, February” will be displayed (Not illustrated).

If any one of the period selection keys 302, 304 and 306 is pressed, the specified period menu 310 showing pieces of processing history information of document files which are processed within the specified period (FIG. 10B).

Processing history selection keys 302, 304 and 306 are touch-sensitive.

Generally, an MFP has only a small display screen compared to a terminal apparatus (e.g. PC 100), and an input unit of the MFP, such as a touch-sensitive panel, is not suitable for keying quickly. Accordingly, the user is often required to spend much time to search for files. Such a problem can be solved by the MFP 1 according to the second embodiment.

In the second embodiment, the case where the document files stored in the MFP 1 are selected is described. However, the structure may be modified so that the MFP 1 obtains document files from another apparatus MFP 2. For realizing this, the operation panel unit of the MFP 1 may display an apparatus selection screen on which the user can select the appratus from which the document files should be obtained.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A document file obtaining method that is used by a document file obtaining apparatus to obtain a processed document file from a document file storing apparatus which stores one or more processed document files in one-to-one association with one or more pieces of processing history information, each including a processing date and time, the document file obtaining method comprising:
a specifying step of specifying, among one or more document file storing apparatuses, a document file storing apparatus from which to obtain a processed document file;
a receiving step of receiving processing history information from the specified document file storing apparatus;
a selecting step of displaying pieces of received processing history information whose processing date and time is within a predetermined time period, and selecting at least one piece of the displayed processing history information; and
an obtaining step of obtaining a document file associated with the selected piece of the processing history information from the specified document file storing apparatus.

2. The document file obtaining method of claim 1, wherein
the predetermined period is a period between a current time and a predetermined time in the past.

3. The document file obtaining method of claim 1, wherein
the receiving step receives pieces of the processing history information whose processing date and time is within the predetermined time period.

4. The document file obtaining method of claim 1, wherein
the selecting step includes:
a periodical classification menu displaying substep of displaying a periodical classification menu including one or more periods into which pieces of the received processing history information are classified based on the time and date;
a period specifying substep of specifying at least one of the periods; and
a specified period menu displaying substep of displaying a specified period menu including one or more pieces of the processing history information classified in the selected period.

5. The document file obtaining method of claim 4, wherein
the periodical classification menu displaying substep displays the menu that includes a first period between a current time and a first predetermined time in the past, and a second period between the first predetermined time and a second predetermined time that is further in the past than the first predetermined time.

6. The document file obtaining method of claim 4, wherein
among the one or more periods included in the periodical classification menu, a period nearer to the current time has a shorter time length.

7. The document file obtaining method of claim 4, wherein
among the one or more periods, the periodical classification menu displays a period in which at least one piece of the processing history information is classified.

8. The document file obtaining method of claim 4, wherein
the specified period menu is displayed as a submenu of the periodical classification menu.

9. The document file obtaining method of claim 4, wherein
each piece of the processing history information further includes a user attribute,
the selecting step includes a user name selection menu displaying substep of displaying a user name selection menu used for selecting a user name of a user of the document file storing apparatus, and
at least one of the periodical classification menu and the specified period menu includes the processing history information which includes the user attribute corresponding to the user name selected from the user name selection menu.

10. The document file obtaining method of claim 9, wherein
the user attribute indicates that the processing history information does not belong to any specific user; and
at least one of the periodical classification menu and the specified period menu includes the processing history information which includes the user attribute indicating that the processing history information does not belong to any specific user.

11. The document file obtaining method of claim 4, wherein
the document file storing apparatus includes a processing unit operable to perform a predetermined processing on a document file,
the processing history information includes information that specifies a type of the processing, and
the specified period menu includes the processing time and date and the type of the processing.

12. The document file obtaining method of claim 11, wherein
the processing performed by the processing unit is at least one of scanning, FAX transmission, printing, and copying.

13. The document file obtaining method of claim 4, wherein
the periodical classification menu is a context menu that is displayed in a window showing contents of a predetermined directory, and
the obtaining step transmits, to the document file storing apparatus, an obtainment request which includes information that specifies the directory as an obtainment target directory.

14. The document file obtaining method of claim 4, wherein
the periodical classification menu displaying substep displays the periodical classification menu in response to a single touch of a key or a button of an input device of the document file obtaining apparatus.

15. The document file obtaining method of claim 14, wherein
the input device is a mouse and the single touch is a single click of a button of the mouse.

16. A document processing apparatus comprising:
a processing unit operable to perform a predetermined processing on a document file;
a storing unit operable to store one or more processed document files in one-to-one association with one or more pieces of processing history information each including a processing date and time;
a display control unit operable to display pieces of the processing history whose processing date and time is within a predetermined time period; and
a receiving unit operable to receive a selection of at least one of the displayed pieces of the processing history information.

17. The document processing apparatus of claim 16, wherein
the document processing apparatus is connected to another document processing apparatus via a network, and further includes:
a receiving unit operable to receive the processing history information from said another document processing apparatus;
an obtaining unit operable to obtain one or more document files in one-to-one association with the one or more pieces of the processing history information, and
the display control unit operable to receive a specification of a document processing apparatus, and if said another apparatus is specified, the receiving unit receives the processing history information from said another document processing apparatus.

18. The document processing apparatus of claim 16, wherein
the display control unit displays a menu including one or more periods into which the pieces of the processing history information are classified based on the time and date,
the receiving unit further receives a selection of at least one of the displayed periods, and
in response to the selection, the display control unit further displays a specified period menu including pieces of the processing history classified in the specified period.

19. A document file obtaining program that is used by a document file obtaining apparatus to obtain a processed document file from a document file storing apparatus which stores one or more processed document files in one-to-one association with one or more pieces of processing history information, each including a processing date and time, the document file obtaining program comprising:
a specifying step of specifying, among one or more document file storing apparatuses, a document file storing apparatus from which to obtain a processed document file;
a receiving step of receiving processing history information from the specified document file storing apparatus;
a selecting step of displaying pieces of received processing history information whose processing date and time is within a predetermined time period, and selecting at least one piece of the displayed processing history information; and
an obtaining step of obtaining a document file associated with the selected piece of the processing history information from the specified document file storing apparatus.

20. The document file obtaining program of claim 19, wherein
the selecting step includes:
a periodical classification menu displaying substep of displaying a periodical classification menu including one or more periods into which pieces of the received processing history information are classified based on the time and date;
a period specifying substep of specifying at least one of the periods; and
a specified period menu displaying substep of displaying a specified period menu including one or more pieces of the processing history information classified in the selected period.
